(19) United States
(12) Patent Application Publication
(10) Pub. No.: US 2023/0255264 A1
(43) Pub. Date: Aug. 17, 2023

(54) Aerosol Generating Device

(71) Applicant: JT International SA, Geneva (CH)

(72) Inventors: Andrew Robert John Rogan, Forres (GB); Alec Wright, Guildford (GB)

(73) Assignee: JT International SA, Geneva (CH)

(21) Appl. No.: 18/005,529

(22) PCT Filed: Jul. 15, 2021
(86) PCT No.: PCT/EP2021/069778

§ 371 Date: Jan. 13, 2023

(30) Foreign Application Priority Data
Jul. 17, 2020 (EP) 20186582.1

(51) Int. Cl. A24F 40/46; A24F 40/20; A24F 40/48; H05B 3/22

(52) U.S. Cl. CPC A24F 40/46; A24F 40/20; A24F 40/48; H05B 3/22

(57) ABSTRACT

An aerosol generating device comprising a heating chamber is disclosed. The heating chamber comprises an opening arranged to receive an aerosol generating medium; and a heating element for heating the aerosol generating medium, wherein the heating element is fixed with respect to the heating chamber, wherein the heating chamber has a base portion that is moveable along a length of the heating chamber, and wherein the base portion comprises at least one piercing element configured to pierce the aerosol generating medium received in the heating chamber.

The present invention relates to an aerosol generating device.

Aerosol generating devices such as electronic cigarettes and heat-not-burn (HNB) devices are relatively well known and are becoming increasingly popular with consumers. A common operating principle for such devices is to heat a consumable without burning it to provide an aerosol (also referred to as a vapour) to a user for inhalation. Examples of such consumables include charges of tobacco material.

Aerosol generating devices often comprise a heater, a power source for supplying electricity to the heater and a receptacle, such as a heating chamber, for receiving the consumable in the vicinity of the heater such that the consumable may be heated to produce the vapour for inhalation.

Within known such devices, there is a need to provide greater flexibility with regard to accommodating different sizes of consumable whilst also ensuring that the consumable is securely positioned within the receptacle and that consumable receives ample air flow to generate the aerosol. If an aerosol generating device is configured to accommodate a number of different sizes of consumable, there also arises a need to prevent non-genuine or uncertified consumables from being received within the aerosol generating device, which could otherwise pose a safety hazard to the user.

An object of the present invention is to provide an aerosol generating device which addresses one or more of these issues.

According to an aspect of the invention, there is provided an aerosol generating device comprising: a heating chamber comprising an opening arranged to receive an aerosol generating medium; and a heating element for heating the aerosol generating medium, wherein the heating element is fixed with respect to the heating chamber, wherein the heating chamber has a base portion that is moveable along a length of the heating chamber, and wherein the base portion comprises at least one piercing element configured to pierce the aerosol generating medium received in the heating chamber.

In this way, the moveable base portion allows consumables of various sizes to be accommodated within the heating chamber whilst the piercing element ensures that the consumable is securely positioned within the heating chamber. Advantageously, the piercing element may ensure that the consumable is positioned within the heating chamber to receive optimal heat transfer from the heating element. The piercing element may also act as an anti-counterfeit measure to ensure that only certified and genuine consumables are able to be received within the heating chamber. Moreover, the piercing element may act as child resistance feature by requiring a threshold level of applied force before the consumable may be received within the heating chamber. The one or more piercing elements may further provide an air flow route into the aerosol generating medium.

Preferably, the base portion is moveable to adjust the length of the heating chamber between the opening and the base portion available for receiving the aerosol generating medium. Preferably, the opening is positioned at one longitudinal end of the heating chamber. In this way, the adjustable length between the moveable base and opening defines the length of a consumable that can be inserted into the chamber.

Preferably, the base portion is moveable relative to the heating element.

Preferably, the aerosol generating device further comprises an airflow passage extending through the base portion, the air flow passage being configured to supply air to the aerosol generating medium received in the heating chamber. In this way, the air flow passage provides an additional or alternative delivery route of air into the heating chamber, thereby providing superior ventilation of the heating chamber and improving the aerosol generating properties of the device.

Preferably, the airflow passage extends along the length of the at least one piercing element, and the air flow passage is configured to supply air through the at least one piercing element into the aerosol generating medium received in the heating chamber. In this way, the airflow passage advantageously delivers air directly into the consumable through the piercing element. As the air is supplied to the interior of the consumable, rather than the exterior of the consumable, the ventilation of the consumable is improved and the aerosol generating efficiency of the device may be increased.

In some examples, the heating element extends around a circumference of the heating chamber, either within or outside the heating chamber. For example, the heating element may be a thin film heating element wrapped around an outer or inner surface of the heating chamber.

Preferably, the heating element extends into the heating chamber. Preferably, the heating element extends through a hole in the base portion towards the opening of the heating chamber, and the base portion is moveable along the length of the heating chamber with respect to the heating element. In this way, the heating element may reliably deliver heat to the consumable received within the heating chamber, regardless of the size of the consumable or the position of the base portion within the heating chamber.

Preferably, the at least one piercing element is located adjacent to the hole in the base portion, and wherein the at least one piercing element has a corresponding piercing element located on an opposing side of the hole in the base portion. In this way, the consumable may be more securely held within the consumable by the two piercing elements. As the piercing elements are arranged symmetrically either side of the hole in the base portion, the stability and positioning of the consumable within the heating chamber may be improved, and a more even airflow may be provided into the consumable.

Preferably, the heating element is a heating blade configured to be inserted into the aerosol generating medium received in the heating chamber. In this way, the heating element may easily be inserted into a consumable, resulting in direct contact of the surface of the heating element with the interior of the consumable.

As a large surface area for heat transfer is provided, the heating efficiency of the aerosol generating device may be improved.

Preferably, the aerosol generating device is configured such that the air is heated prior to being supplied along the air flow passage. In this way, the air is pre-heated before being delivered to the heating chamber such that the amount of energy required to heat and vaporise the consumable within the heating chamber may be reduced and the efficiency of the aerosol generating device may be improved. Moreover, the vapour may be provided to the user at a more favourable temperature, therefore improving the user experience.

Preferably, the aerosol generating device further comprises an air flow path arranged to transport air from an air inlet in the aerosol generating device to the air flow passage extending through the base portion and into the aerosol generating medium received in the heating chamber. Preferably the air flow path is configured such that it passes close to a portion of the heating element such that air is heated as it passes along the air flow path before reaching the aerosol generating medium. Preferably, the air inlet is located on an opposite side of the base portion to the opening of the heating chamber. Preferably, the air flow path comprises a heating zone for heating the air prior to the air being supplied along the air flow passage and into the aerosol generating medium received in the heating chamber.

Preferably, the heating chamber is tubular.

Embodiments of the invention are now described, by way of example, with reference to the drawings, in which:

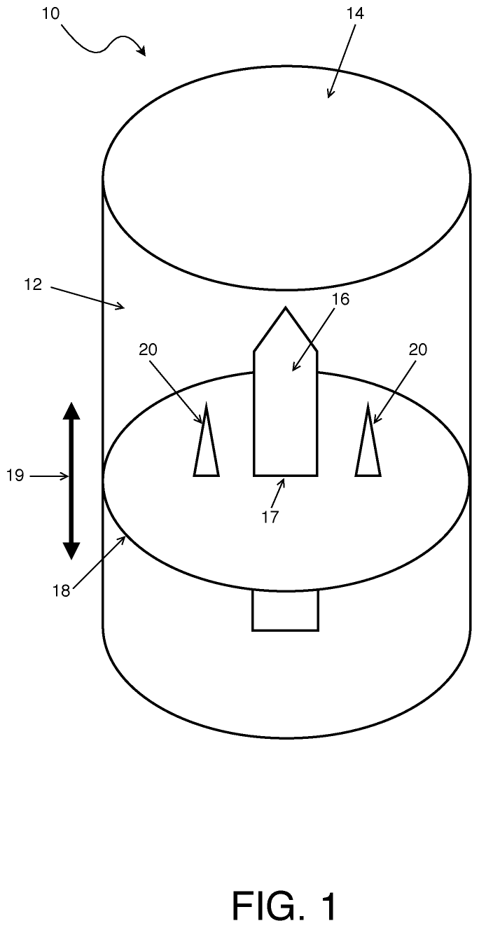

FIG. 1 is schematic perspective view of an aerosol generating device in an embodiment of the invention;

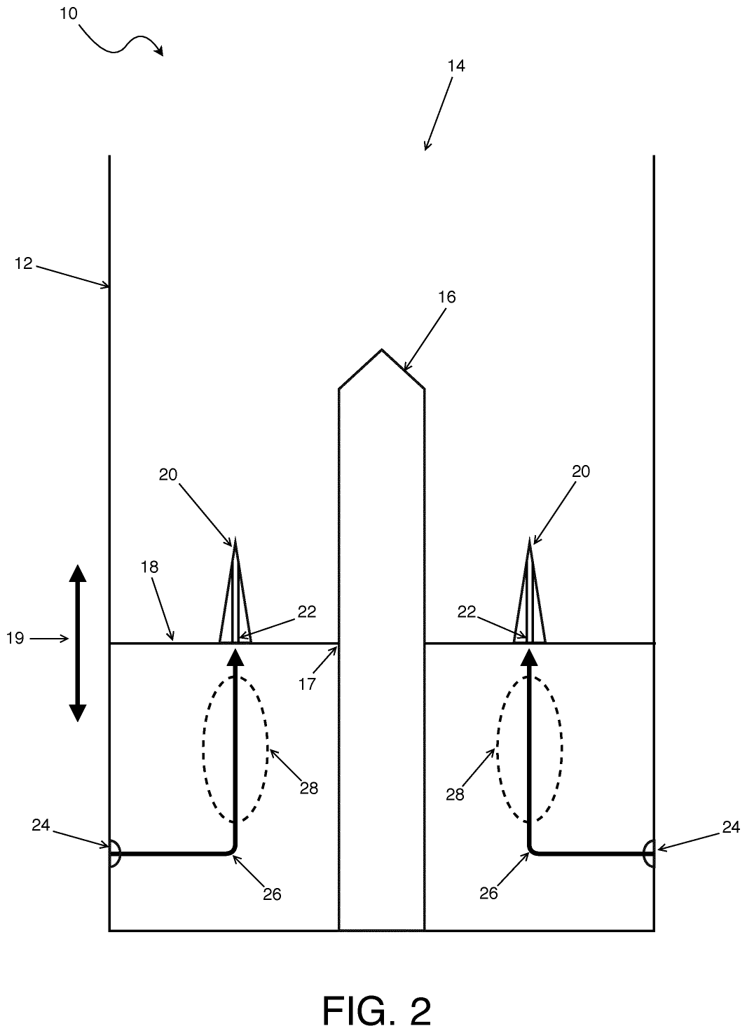

FIG. 2 is schematic side-view of the aerosol generating device;

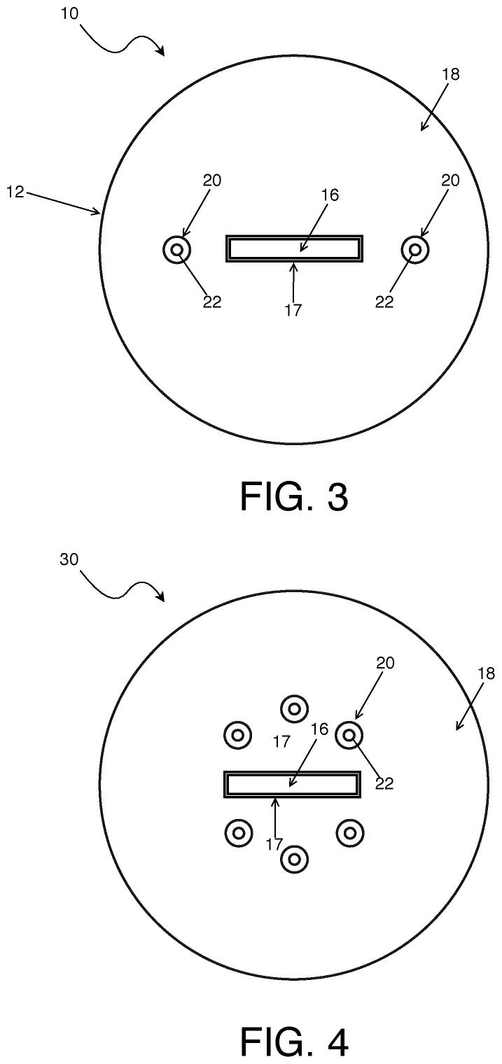

FIG. 3 is a schematic top-view of the aerosol generating device; and

FIG. 4 is a schematic top-view of an aerosol generating device in another embodiment of the invention.

FIG. 1 shows an aerosol generating device 10 comprising a heating chamber 12 and a heating element 16. For simplicity, additional components of the aerosol generating device 10 have been omitted from the figures, such as a power supply (e.g. battery), a housing, and electronics. The heating chamber 12 is tubular (e.g. cylindrical) and has an opening 14 disposed at a first end of its length. The opening 14 is configured for receiving a consumable (e.g. capsule), such as a rod of tobacco or other aerosol generating medium. In particular, the opening 14 is shaped so that a user may easily insert the consumable into the opening 14 such that the consumable is held within the heating chamber 12. The skilled person will appreciate that, in alternative examples, the heating chamber 12 may be formed in various alternative shapes (such as a cuboid, a hemi-sphere, a cone, or a triangular prism etc.) and the opening 14 may be configured to receive the alternative shape of consumable.

The heating chamber 12 comprises a base portion 18 which is moveable along the length of the heating chamber 12. The base portion 18 is configured to move with respect to the heating chamber 12 such that the distance between the base portion 18 and the opening 14 defines the length (and thus volume) of the heating chamber 12 available for receiving the consumable. Advantageously, this allows consumables of different sizes, and in particular different lengths, to be accommodated within the heating chamber 12. For example, if a long consumable is intended to be used with the aerosol generating device 10, the base portion 18 may be moved along the heating chamber 12 away from the opening 14, thereby increasing the length of the heating chamber 12 between the opening 14 and the base portion 18. Conversely, if a short consumable is intended to be used with the aerosol generating device 10, the base portion 18 may be moved along the heating chamber 12 towards the opening 14, thereby decreasing the length of the heating chamber 12 between the opening 14 and the base portion 18.

The size (shape, area) of the base portion 18 corresponds to the cross-sectional area of the heating chamber 12 (and the area of the opening 14). In this example, as the heating chamber 12 is tubular, the base portion 18 is formed as a disc of material. The skilled person will appreciate that, in other examples, the base portion 18 may be formed as an alternative shape that conforms to the cross-sectional area of the heating chamber 12 and is suitable for being moved along the length of the heating chamber 12. For example, if the heating chamber 12 is cuboidal, the base portion 18 may be formed as a square of material.

The base portion 18 is moved along the length of the heating chamber 12 by an actuation mechanism 19. In one example, the actuation mechanism 19 may be a mechanical mechanism, such as a sliding mechanism wherein the base portion 18 moves along the length of the heating chamber 12 on one or more sliding rails. In other examples, the actuation mechanism 19 may be another mechanism suitable for moving the base portion 18 along the length of the heating chamber 12. The actuation mechanism 19 may be manually operated, for example by the user actuating a sliding switch on the exterior of the heating chamber 12. Alternatively, the actuation mechanism 19 may be operated by electronic or other means.

In some examples, the moveable base portion 18 may be resiliently biased, such as by a spring, to a first position, or extended position, within the heating chamber 12 toward the opening 14. The first position can be substantially central to the length of the heating chamber 12, or toward the opening 14. When the consumable is pushed into the heating chamber 12, it presses against the moveable base portion 18 and the base portion 18 moves downward in the heating chamber 12, away from the opening 14, against the resiliently biasing force. A frictional force between the consumable and the internal walls of the heating chamber 12 overcomes the resilient biasing force so as to hold the consumable in place with the moveable base portion 18 in a second position, or retracted position, that is farther from the opening 14 of the heating chamber 12. That is, the base portion 18 is moveable between an extended position at a first distance from the opening 10, and a retracted position at a second distance from the opening 14, the second distance being greater than the first distance.

The heating element 16 extends from a second end of the heating chamber 12, which opposes the first end of the heating chamber 12 having the opening 14, through a hole 17 in the base portion 18 and into the heating chamber 12. The hole 17 in the base portion 18 is located substantially in the centre of the base portion 18 and is substantially the same size and shape as the cross-section of the heating element 16. A seal (not illustrated) may be provided within the hole 17 between the base portion 18 and the heating element 16 to prevent air inadvertently leaving and/or entering the heating chamber 12. In this example, the heating element 16 is a heating blade, i.e. a flat, wide heating element with a sharp leading edge extending into the heating chamber 12. The heating element 16 lies parallel to the length of the heating chamber 12 and extends approximately along the central (longitudinal) axis of the heating chamber 12 such that it is positioned for insertion into the consumable received within the heating chamber 12. Advantageously, this provides the heating element 16 with a large area of heating which may directly contact the consumable for an efficient transfer of heat.

The heating element 16 is fixed with respect to the heating chamber 12. When the base portion 18 is moved along the length of the heating chamber 12, the heating element 16 remains stationary and the base portion 18 moves along the length of the heating element 16, thereby changing the length of the heating element 16 situated within the heating chamber 12 between the opening 14 and the base portion 16.

The skilled person will appreciate that the heating element 16 may be formed in various other arrangements. For example, the heating element 16 may at least partially surround, or preferably entirely surround, the interior (e.g. circumference) of the heating chamber 12 such that, in use, the exterior of the consumable received within the heating chamber 12 is heated. In another example, the heating element 16 may be a heating spike or heating rod that protrudes through the complimentary shaped hole 17 in the base portion 18 and into the heating chamber 12.

The base portion 18 comprises one or more piercing elements 20 configured to pierce the consumable received within the heating chamber 12. In this embodiment, the base portion 18 comprises two piercing elements 20 located on opposing sides of the hole 17 in the base portion 18. Each piercing element 20 has a sharp and/or narrow point extending into the heating chamber 12, e.g. the piercing element 20 is shaped like a needle, spike or other shape which may be used to pierce the consumable.

In use, the user may insert the consumable through the opening 14 and into the heating chamber 12. In order for the consumable to be correctly positioned and properly received within the heating chamber 12, the user must apply a force sufficient to pierce the consumable with the piercing elements 20. On application of this threshold force, the consumable is positioned within the heating chamber 12 such that one end of the consumable lies flush with the base portion 18.

Advantageously, the piercing elements 20 provide a safeguard against use of the aerosol generating device 10 by children as the force required to pierce a consumable means that accidental insertion of a consumable is avoided. Moreover, the one or more piercing elements 20 may operate as an anti-counterfeit measure to avoid the use of the aerosol generating device 10 with non-genuine or uncertified consumables.

In particular, in some examples, the consumable may comprise a housing configured to contain an aerosol generating material. The housing has a surface configured to engage with the aerosol generating device 10, i.e. the piercing elements 20 are configured to engage and pierce the surface of the consumable when the base portion 18 and consumable are brought into connection with one another. The surface comprises a breakable, or frangible, material layer configured to be broken upon interaction with the piercing elements 20 and a protective barrier layer configured to be resistant to the one or more piercing elements 20. In examples, the breakable material layer can comprise aluminium foil, HDPE, silicon or paper, and the protective barrier layer can comprise cardboard, a steel plate, a high temperature plastics such as polyimide, or nylon.

The breakable material layer and the protective barrier layer are arranged such that the protective barrier layer defines one or more breakable, or frangible, regions in the surface. The protective barrier layer is formed from a resilient material that cannot be readily pierced by the piercing elements 20. That is, the protective barrier layer inhibits the piercing elements 20 from piercing some regions (i.e. non-breakable regions) of the surface, but allows for the piercing of other regions (i.e. the breakable regions) of the surface.

The one or more breakable regions can be defined by one or more openings, or through-holes, in the protective barrier layer. That is, the surface of the consumable comprises a layer of barrier material over a layer of breakable material, such that the layer of barrier material is the outermost layer. A series of openings forming the breakable regions can be patterned in the barrier layer to expose the breakable material.

In this way, the consumable can only engage the piercing elements 20 when properly arranged in the chamber. Specifically, the one or more breakable regions are arranged to be aligned with cooperating piercing elements of the piercing elements 20 of the aerosol generating device 10 such that the surface is pierceable by the piercing elements 20 when the arrangement of the breakable regions coincides with an arrangement of the piercing elements 20.

That is, the breakable regions in the surface of the consumable can be configured to have a corresponding layout to the piercing elements 20 on the base portion 18 of the aerosol generating device 10. In this way, only consumables in which the arrangement of the breakable regions matches the arrangement of the piercing elements 20 of an aerosol generating device 10 can be used with the aerosol generating device 10. When one or more of the piercing elements 20 do not align with a breakable region, the piercing element 20 abuts the protective barrier layer which cannot be readily pierced by the piercing element 20. This inhibits the engagement of a consumable with a breakable region layout that does not match the piercing element 20 layout of the aerosol generating device 10. This can prevent the use of unauthorised, or non-compatible, capsules with the aerosol generating device.

For example, in use, when the consumable is inserted into the heating chamber 14, the piercing elements 20 align with the breakable regions and pierce the breakable regions. In the case of a resiliently biased moveable base portion 18, the resilient biasing force is strong enough to allow the piercing elements 20 to pierce the breakable regions without causing the base portion 18 to retract into the heating chamber 12. When the piercing elements 20 have pierced and engaged the breakable regions, the moveable base portion 18 is then pushed deeper into the heating chamber 12 as the user continues to push the consumable into the heating chamber 12.

FIG. 2 is a cross-sectional side-view of the aerosol generating device 10 taken through the plane of the heating element 16. FIG. 3 is a cross-sectional top-view of the aerosol generating device 10 taken in the plane of the base portion 18. As illustrated, each piercing element 20 comprises an air flow passage 22 extending along the length of the piercing element 20. The air flow passage 22 is arranged to supply air through (i.e. along) the piercing element 20 and into the heating chamber 12. In use, air is thus supplied directly into the consumable that has been received within the heating chamber 12 and pierced by the piercing element 20. This mode of operation improves the ventilation of the consumable, thereby increasing the efficiency of aerosol generation within the aerosol generating device 10.

Air may enter the aerosol generating device 10 through an air inlet 24 which is located in a wall of the heating chamber 12. The air inlet 24 is positioned on an opposite side of the base portion 18 to the opening 14. After entering through the air inlet 24, the air is delivered along an air flow path 26 which connects the air inlet 24 to the air flow passage 22. Thus, air may be supplied through the air inlet 24, along the air flow path 26, through the air flow passage 22, and into the consumable received within the heating chamber 12. Furthermore, the air inlet 24 may comprise a valve (not illustrated) which can be adjusted (e.g. opened and closed) to adjust the airflow to heating chamber 12 and/or consumable.

In this example, the air flow path 26 comprises a heating zone 28 for heating the air supplied along the air flow path 26, prior to the air being delivered to the consumable within the heating chamber 12. In this way, the amount of energy supplied to the heating element 16 may be reduced as pre-heated air is supplied to the heating chamber 12. The skilled person will appreciate that the heating zone 28 may comprise one or more heaters or any other suitable forms of heating mechanism.

In alternative embodiments, the air flow passage 22 may additionally or alternatively extend through a flat portion of the base portion 18 (rather than through the piercing element 20), thereby providing a supply of air into the heating chamber 12 rather than directly into the consumable. In an alternative embodiment, the air flow passage 22 may additionally or alternatively extend within and along the length of the heating element 16, such that the heating element 16 may heat the air prior to the air being delivered into the consumable within the heating chamber 12.

FIG. 4 is a cross-sectional top-view of an aerosol generating device 30 taken in the plane of the base portion 18 in another embodiment of the invention. In this embodiment, the base portion 18 comprises six piercing elements 20 with respective airflow passages 22 extending along the axial length of each piercing element 20. The piercing elements 20 are arranged in an approximate ring around the hole 17 in the base portion 18. In particular, each piercing element 20 is located adjacent to the hole 17 in the base portion, with each piercing element 20 having a corresponding piercing element 20 located on an opposing side of the hole 17 in the base portion 18. This symmetrical arrangement of the piercing elements 20 either side of the hole 17 in the base portion 18 may lead to improved stability of the pierced consumable held within the heating chamber 12. The skilled person will appreciate, however, that the piercing elements 20 need not be symmetrically arranged around the hole 17 in the base portion 18 and, for example, the piercing elements 20 may be entirely absent in the base portion 18 on one side of the hole 17.

1. An aerosol generating device comprising:
a heating chamber comprising an opening arranged to receive an aerosol generating medium; and
a heating element for heating the aerosol generating medium, wherein the heating element is fixed with respect to the heating chamber,
wherein the heating chamber has a base portion that is moveable along a length of the heating chamber, and
wherein the base portion comprises at least one piercing element configured to pierce the aerosol generating medium received in the heating chamber.

2. The aerosol generating device of claim 1, wherein the base portion is moveable to adjust the length of the heating chamber between the opening and the base portion available for receiving the aerosol generating medium.

3. The aerosol generating device of claim 1, further comprising an air flow passage extending through the base portion, the air flow passage being configured to supply air to the aerosol generating medium received in the heating chamber.

4. The aerosol generating device of claim 3, wherein the air flow passage extends along a length of the at least one piercing element, and wherein the air flow passage is configured to supply air through the at least one piercing element into the aerosol generating medium received in the heating chamber.

5. The aerosol generating device of claim 3, configured such that the air is heated prior to being supplied along the air flow passage.

6. The aerosol generating device of claim 3, further comprising an air flow path arranged to transport air from an air inlet in the aerosol generating device to the air flow passage extending through the base portion and into the aerosol generating medium received in the heating chamber.

7. The aerosol generating device of claim 6, wherein the air inlet is located on an opposite side of the base portion to the opening of the heating chamber.

8. The aerosol generating device of claim 6, wherein the air flow path comprises a heating zone for heating the air prior to the air being supplied along the air flow passage and into the aerosol generating medium received in the heating chamber.

9. The aerosol generating device of claim 1, wherein the heating element extends into the heating chamber.

10. The aerosol generating device of claim 9, wherein the heating element extends through a hole in the base portion towards the opening of the heating chamber, and wherein the base portion is moveable along the length of the heating chamber with respect to the heating element.

11. The aerosol generating device of claim 10, wherein the at least one piercing element is located adjacent to the hole in the base portion, and wherein the at least one piercing element has a corresponding piercing element located on an opposing side of the hole in the base portion.

12. The aerosol generating device of claim 1, wherein the heating element is a heating blade configured to be inserted into the aerosol generating medium received in the heating chamber.

13. The aerosol generating device of claim 1, wherein the heating chamber is tubular.
